(19) United States
(12) Patent Application Publication
(10) Pub. No.: US 2009/0097555 A1
(43) Pub. Date: Apr. 16, 2009

(54) Video encoding method and device

(75) Inventors: Marc Baillavoine, Versailles (FR); Joel Jung, Le Mesnil Saint Denis (FR); Jean-Christophe Amiel, Paris (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/794,808

(22) PCT Filed: Dec. 15, 2005
(86) PCT No.: PCT/FR05/03149

§ 371 Date: Oct. 19, 2007

(30) Foreign Application Priority Data
Jan. 7, 2005 (FR) 0500172

(51) Int. Cl. H04N 7/32

(52) U.S. Cl. 375/240.12; 375/E07.243

(57) ABSTRACT

Successive images (F) of a video sequence are encoded in order in generate parameters which are included in an output flow (F) that is to be transmitted to a decoder. The encoding of certain images is effected in Inter mode relative to one or several previous images of the sequence. The output flow also includes long term marking commands for certain images and demarking commands for previously marked images. Each long-term marked image is kept in a memory by the decoder until a corresponding demarking command is received. Return information on the restoration of the images of the video sequence by the decoder is received by the encoder (1) and analyzed in order to identify an image that has been lost by the decoder. It is possible to encode a following image of the sequence in Inter mode in relation to a long-term marked image in response to identification of an image lost to the decoder.

The present invention relates to video coding techniques.

It applies to situations where a coder producing a coded video signal stream sent to a video decoder benefits from a return channel, on which the decoder side provides information indicating, explicitly or implicitly, whether or not it has been possible to appropriately reconstruct the pictures of the video signal.

Many video coders support an inter-picture coding mode (“inter-frame coding”, hereinafter Inter coding), in which the motion between the successive pictures of a video sequence is estimated so that the most recent picture is coded in relation to one or more previous pictures. A motion estimation is performed in the sequence, the estimation parameters are quantized and dispatched to the decoder, and the estimation error is transformed, quantized and dispatched to the decoder.

Each picture of the sequence can also be coded without reference to the others. This is what is called Intra coding (“intra-frame coding”). This coding mode utilizes the spatial correlations within a picture. For a given transmission throughput from the coder to the decoder, it affords inferior video quality to Inter coding since it does not exploit the temporal correlations between the successive pictures of the video sequence.

Commonly, a video sequence portion has its first picture Intra coded then the following pictures Inter coded. Information included in the output stream from the coder indicates the Intra and Inter coded pictures and, in the latter case, the reference picture or pictures(s) to be employed.

New coding standards, in particular the H.264 standard of the International Telecommunications Union (“Advanced video coding for generic audiovisual services”, ITU-T, May 2003), allow the coder to mark long-term certain pictures of the sequence in the output stream, so as to indicate to the decoder that it must retain these pictures in memory once they have been reconstructed. These marked pictures are called “long-term pictures” in the standard. Unless indicated otherwise by the coder, the decoder retains these pictures in its memory. These marked pictures have to be distinguished from the pictures termed “short-term pictures” which are erased from the memory of the decoder as the video sequence is played back.

A problem with Inter coding is its behavior in the presence of transmission errors or packet losses over the communication channel between the coder and the decoder. The degradation or the loss of a picture propagates over the following pictures until a new Intra coded picture arises.

It is commonplace for the mode of transmission of the coded signal between the coder and the decoder to cause total or partial losses of certain pictures. Such losses result for example from the loss or the overly late arrival of certain data packets when the transmission takes place over a packet network with no guarantee of delivery such as an IP (Internet Protocol) network. Losses can also result from errors introduced by the transmission channel beyond the correction capabilities of the error-correcting codes employed. In an environment prone to diverse losses of signal, it is necessary to provide mechanisms for improving the quality of the picture at the decoder. One of these mechanisms is the use of a return channel, from the decoder to the coder, on which the decoder informs the coder that it has lost all or some of certain pictures. In certain cases, it is the properly reconstructed pictures that the decoder indicates to the coder and the latter can, on the contrary, deduce therefrom which pictures may possibly have been lost.

The coder can then make coding choices to correct or at least reduce the effects of the transmission errors. Current coders simply return an Intra coded picture, that is to say without reference to the pictures previously coded in the stream and that might contain errors.

These Intra pictures make it possible to refresh the display and to correct errors due to transmission losses. But they are of inferior quality to the Inter pictures. Thus, the usual mechanism for compensating for picture losses gives rise despite everything to a degradation in the quality of the signal played back for a certain time after the loss.

An aim of the present invention is to improve the quality of a video signal following transmission errors when a return channel is present from the decoder to the coder.

The invention thus proposes a video coding method, comprising the following steps:
coding successive pictures of a video sequence so as to generate coding parameters, the coding of at least one picture being effected in relation to at least one previous picture of the video sequence;
including the coding parameters in an output stream to be transmitted to a station comprising a decoder;
including in the output stream long-term marking commands for certain pictures of the video sequence and commands for unmarking pictures previously marked long-term, each picture marked long-term having to be retained in memory by the decoder until receipt of a command for unmarking said picture;
receiving, from said station, return information about the playback of the pictures of the video sequence by the decoder; and
analyzing the return information so as to identify pictures that have not been played back or have been played back poorly by the decoder and, in response to the identification of a picture that has not been played back or has been played back poorly, coding at least one following picture of the video sequence in relation to a previous picture of the video sequence selected from among pictures comprising at least one picture marked long-term.

The pictures marked long-term can be used as reference pictures for the Inter coding, like any other picture of a video sequence. The method according to the invention makes it possible to maintain the Inter coding mode when losses are detected, by including one or more long-term pictures in a set of previous pictures that the coder can choose as reference to restart the Inter coding after the detection of a picture loss. These pictures marked long-term avoid the need to make compulsory reference to the short-term pictures, which the decoder retains in only a transient manner in its memory. These short-term pictures are also at risk of being corrupted on account of the observed loss, and it is very useful to be able, if required, to also make reference to long-term pictures.

For a given transmission throughput, a better quality of video playback is thus obtained once the channel has reverted to a lossless state.

The method advantageously uses suitable strategies for long-term marking of the pictures of the video sequence, such as for example:
use of change of shot detection to mark long-term a picture which immediately follows a change of shot. This technique makes it possible to ensure that the reference picture will be close to the picture to be coded;
in the case where the return channel informs the coder of the pictures received properly, with no decoding error, long-term marking of certain ones of these pictures by the coder. Here it is ensured that the pictures used as “long-term pictures” do not contain any errors;
in the case where the network informs the coder of its state, for example in terms of percentage losses, the coder can mark long-term, in a regular manner, the pictures of the stream which are not affected by the losses in the network. When losses occur, the process of regular marking of the coded pictures is interrupted. It is thus ensured that there will indeed be reference pictures in memory when a loss occurs.

Another aspect of the invention pertains to a computer program to be installed in a video processing apparatus, comprising instructions for implementing the steps of a video coding method such as defined above during an execution of the program by a calculation unit of said apparatus.

Another aspect of the invention pertains to a video coder, comprising:
means for coding successive pictures of a video sequence so as to generate coding parameters, the coding of at least one picture being effected in relation to at least one previous picture of the video sequence;
means for forming an output stream of the coder to be transmitted to a station comprising a decoder, the output stream including said coding parameters as well as long-term marking commands for certain pictures of the video sequence and commands for unmarking pictures previously marked long-term, each picture marked long-term having to be retained in memory by the decoder until receipt of a command for unmarking said picture;
means for receiving, from said station, return information about the playback of the pictures of the video sequence by the decoder; and
means for analyzing the return information so as to identify pictures that have not been played back or have been played back poorly by the decoder and, in response to the identification of a picture that has not been played back or has been played back poorly, controlling the coding means so that at least one following picture of the video sequence is coded in relation to a previous picture of the video sequence selected from among pictures comprising at least one picture marked long-term.

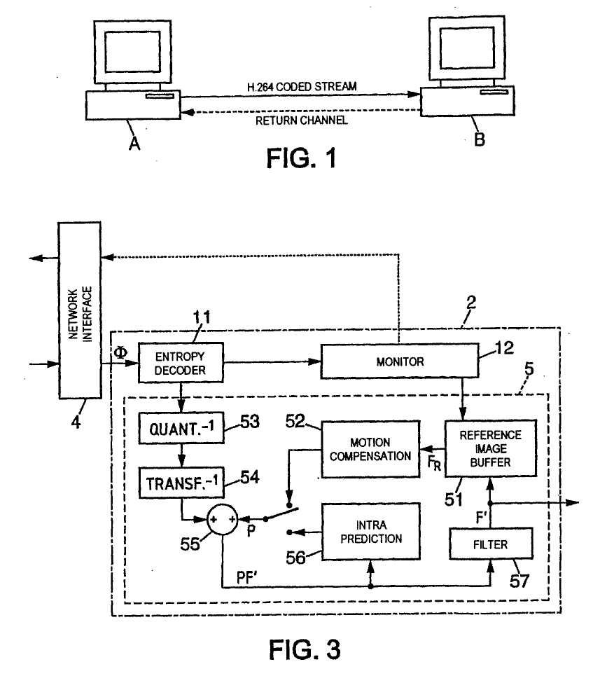

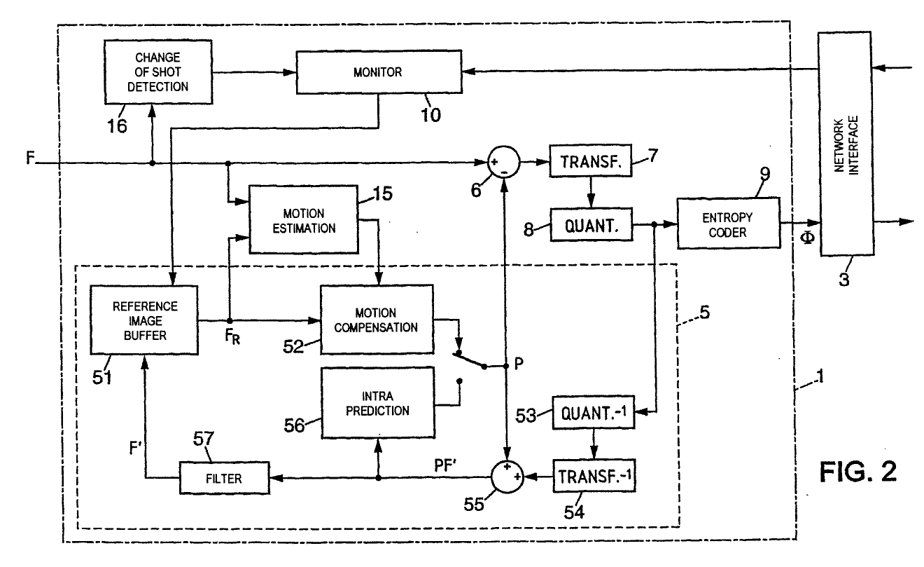

Other features and advantages of the present invention will appear in the description hereinafter of nonlimiting exemplary embodiments, with reference to the appended drawings, in which:
FIG. 1 is a diagram showing two stations in communication, provided with video coders/decoders;
FIG. 2 is a schematic diagram of a video coder according to the invention;
FIG. 3 is a schematic diagram of a video decoder able to play back pictures coded by the coder of FIG. 2.

The coding method according to the invention is for example applicable to videoconferencing over an IP network (prone to packet losses), between two stations A and B (FIG. 1). These stations communicate directly, in the sense that no video transcoding equipment participates in their communication. Each station A, B uses video media coded according to a standard which supports the concept of long-term picture marking, for example the ITU-T H.264 standard.

In a prior negotiation phase, for example performed by means of the ITU-T H.323 protocol well known in the field of videoconferencing over IP, the stations A, B have agreed on an H.264 configuration with long-term marking and also to establish a return channel.

In the exemplary application to videoconferencing, each station A, B is naturally equipped at one and the same time with a coder and a decoder (codec) . Here, we will assume that station A is the sender which contains the video coder 1 (FIG. 2) and that station B is the receiver which contains the decoder 2 (FIG. 3). We are therefore concerned with the H.264 stream sent from A to B and with the return channel from B to A.

The stations A, B consist for example of personal computers, as in the illustration of FIG. 1, each being equipped with video picture capture and playback systems, with a network interface 3, 4 for linkup to the IP network, as well as videoconferencing software executed by the central unit of the computer. For the video codec, this software relies on programs implementing H.264. On the coder side, the program is suitable for including the features described hereinafter. Of course, the codec can also be implemented with the aid of a specialized processor or a specific circuit. The method described can also accommodate coding standards other than H.264.

In H.264, the video picture reconstruction module of the decoder 2 is also found in the coder 1. This reconstruction module 5 is visible in each of FIGS. 2 and 3; it is composed of substantially identical elements bearing the same numerical references 51-57. The prediction residual of a current picture F, that is to say the difference calculated by a subtracter 6 between the picture F and a predicted picture P, is transformed and quantized by the coder 1 (modules 7, 8 of FIG. 2).

An entropy coding module 9 constructs the output stream φ of the coder 1 which includes the coding parameters of the successive pictures of the video sequence (prediction and quantization parameters of the transformed residual) as well as various monitoring parameters obtained by a monitoring module 10 of the coder.

These monitoring parameters indicate in particular which coding mode (Inter or Intra) is used for the current picture and, in the case of Inter coding, the reference picture or pictures to be employed.

On the decoder side, the stream φ received by the network interface 4 is submitted to an entropy decoder 11 which recovers the coding parameters and the monitoring parameters, the latter being provided to a monitoring module 12 of the decoder. The monitoring modules 10, 12 supervise respectively the coder 1 and the decoder 2 by providing them with the commands necessary for ascertaining the coding mode employed, designating the reference pictures in Inter coding, configuring and parametrizing, i.e. tuning, the transformation, quantization and filtering elements, etc.

For the Inter coding, each usable reference picture F_{R} is stored in a buffer memory 51 of the reconstruction module 5. Said memory contains a window of N reconstructed pictures immediately preceding the current picture (short-term pictures) and possibly one or more pictures that the coder has marked specially (long-term pictures).

The number N of short-term pictures retained in memory is monitored by the coder 1. It is usually limited so as not to occupy too many resources of the stations A, B. The refreshing of these short-term pictures occurs after N pictures of the video stream.

Each picture marked long-term is retained in the buffer memory 51 of the decoder (and in that of the coder) until the coder produces a corresponding unmarking command. Thus, the monitoring parameters obtained by the module 10 and inserted into the stream c also comprise the commands for marking and unmarking the long-term pictures.

The prediction parameters for the Inter coding are calculated in a known manner by a motion estimation module 15 as a function of the current picture F and of one or more reference pictures F_{R}. The predicted picture P is generated by a motion compensation module 13 on the basis of the reference picture or pictures F_{R} and of the prediction parameters calculated by the module 15.

The reconstruction module 5 comprises a module 53 which recovers the transformed parameters quantized according to the quantization indices produced by the quantization module 8. A module 54 operates the inverse transformation of the module 7 so as to recover a quantized version of the prediction residual. This is added to the blocks of the predicted picture P by an adder 55 to provide the blocks of a preprocessed picture PF′. The preprocessed picture PF′ is ultimately processed by a deblocking filter 57 to provide the reconstructed picture F′ delivered by the decoder and recorded in its buffer memory 51.

In Intra mode, a spatial prediction is performed in a known manner in tandem with the block coding of the current picture F. This prediction is performed by a module 56 on the basis of the already available blocks of the preprocessed picture PF′.

For a given coding quality, the transmission of Intra coded parameters generally requires a greater throughput than that of Inter coded parameters. Stated otherwise, for a given transmission throughput, the Intra coding of a picture of a video sequence affords inferior quality to its Inter coding.

The selection between the Intra and Inter modes for a current picture is performed by the coder monitoring module 10, for example by being based on detecting the changes of shot within the video sequence. In a known manner, a change of shot can be decided by a detector 16 of the video coder 1 by observing whether the difference between two successive pictures of the sequence has an energy above a detection threshold. In the absence of losses, the picture where a change of shot is detected is typically Intra coded, while the other pictures of the sequence are Inter coded.

To minimize the degradation in quality following the detection of total or partial picture loss with the aid of the information received on the return channel, the method according to the invention favors the resumption of the coding not in Intra but in Inter mode. The method arranges for it to be possible for this resumption of the Inter coding to be done in relation to a reference picture previously marked long-term.

The monitoring module 10 of the coder receives and analyzes the information of the return channel. At the moment it is informed of a picture loss at the decoder 2, the current picture can be coded in the following manner:
in Inter with respect to a reference picture corresponding to the last picture marked long-term if the detector 16 has signaled no change of shot between this reference picture and the current picture;
in Intra if such a change of shot has occurred.

It should be noted that, in certain cases, the monitoring module 10 will be able to decide to resume the Inter coding in relation to a reference picture still present in the window of N short-term pictures retained temporarily by the decoder. For example, if the stations A, B communicate according to a picture acknowledgment protocol and if the coder 1 notes that a recent picture, still present in the window of N short-term pictures, has been acknowledged, it will be able to prefer to resume the Inter coding in relation to this picture, in particular if it is more recent than the last picture marked long-term.

The monitoring module 10 furthermore manages the long-term marking of the pictures of the video sequence.

In an advantageous embodiment, each detection of a change of shot by the detector 16 gives rise to the long-term marking by the monitoring module 10 of a picture following the change of shot detected, preferably the first picture following the change of shot. In a concomitant manner, the monitoring module 10 can address a command for unmarking the picture (or pictures) previously marked long-term to the decoder.

The return channel can be organized in several ways.

In a simple case, it just informs that losses have occurred on the network, without affording other information and in particular without identifying which pictures have been lost. This return information is generally produced upstream of the decoder, for example by the protocol layers (in particular RTCP, “Real Time Control Protocol”) of the network interface 4 of station B. They usually proceed by negative acknowledgments, signaling bad reception of the stream by station B, but could also carry positive acknowledgments, signaling good reception of the stream by station B.

In an embodiment of the method relying on such a return channel, as time passes the monitoring module 10 determines lossless phases in which the stream is properly received by station B (no loss signaled during a latency time of a few seconds for example) and phases with losses in which reception of the stream by station B is disturbed. In the lossless phases, it marks pictures of the video sequence in a regular manner, for example with a periodicity of a few tens to a few hundreds of pictures. In the phases with losses, the monitoring module 10 interrupts this regular marking so as to minimize the risk of using a corrupted reference picture.

Other return channel techniques can be envisaged. The return channel can in particular provide more details on the quantity and the location of the lost information, for example on the loss of a part of a picture or on the number of the lost picture. This kind of return information originates from the video decoder itself, as indicated by the dashed line in FIG. 3. There also, this return information may be in the form of positive acknowledgments (signals the pictures of the sequence which have been played back) or negative acknowledgments (signals the pictures of the sequence which could not be played back). Such methods are for example employed in the ITU-T H.263+ standard (Appendix N) and are transposable to other standards such as H.264.

With a return channel thus organized, it is advantageous that the monitoring module 10 long-term marks pictures of the video sequence that are selected (for example in a regular manner or following changes of shot) from among pictures which it knows have been properly played back. It is thus guaranteed that the reference picture employed will indeed be present at the decoder.

In practice, it may happen that the loss message transferred from the decoder to the coder arrives with a delay which will have allowed the loss to propagate for a few pictures. The improvement related to the invention proposed nevertheless remains effective, since the transmission lag on the return channel would have similarly affected the Intra coding of the picture following awareness of the loss by the monitoring module 10.

An advantageous refinement of the method uses information redundancy to transmit the pictures marked long-term to the decoder, thereby increasing the probability of availability of the pictures in the memory 51 of the decoder in the event of difficulties of transmission between the two stations A, B. Such a redundancy is provided for in the H.264 standard (“redundant coded picture”).

In a similar manner, it is possible to ensure optimal coding quality during error correction, by coding the pictures marked long-term with an excellent quality, or at least a greater quality than the other pictures of the video sequence. This is readily achieved, for example by decreasing the quantization stepsize applied by the module 8. To comply with the target throughput, this may make it expedient to drop the coding of the picture immediately following the marked picture. Picture prediction with respect to the picture marked long-term following a subsequent loss will then be improved.

1. A video coding method, comprising the following steps:
coding successive pictures (F) of a video sequence so as to generate coding parameters, the coding of at least one picture being effected in relation to at least one previous picture of the video sequence;
including the coding parameters in an output stream (c) to be transmitted to a station (B) comprising a decoder (2);
including in the output stream long-term marking commands for certain pictures of the video sequence and commands for unmarking pictures previously marked long-term, each picture marked long-term having to be retained in memory by the decoder until receipt of a command for unmarking said picture;
receiving, from said station, return information about the playback of the pictures of the video sequence by the decoder; and
analyzing the return information so as to identify pictures that have not been played back or have been played back poorly by the decoder and, in response to the identification of a picture that has not been played back or has been played back poorly, coding at least one following picture of the video sequence in relation to a previous picture of the video sequence selected from among pictures comprising at least one picture marked long-term.

2. The method as claimed in claim 1, furthermore comprising a step of detecting a change of shot in the video sequence and, in response to the detection of a change of shot, the long-term marking of a picture following the detected change of shot.

3. The method as claimed in claim 1 or 2, in which the return information comprises information produced upstream of the decoder (2), signaling good or bad reception of the stream by said station (B).

4. The method as claimed in claim 3, in which the analysis of the return information comprises the determination of first phases in which the stream is properly received by the station (B) and of second phases in which the reception of the stream by the station is disturbed, and in which a long-term marking of pictures of the video sequence is performed regularly in each first determined phase and is interrupted in each second determined phase.

5. The method as claimed in any one of the preceding claims, in which the return information comprises information arising from the decoder (2), signaling the pictures of the sequence which have or have not been played back.

6. The method as claimed in claim 5, in which pictures of the video sequence that are selected from among pictures which, according to the return information, have been properly played back are long-term marked.

7. The method as claimed in any one of the preceding claims, in which the coding parameters of the pictures marked long-term are transmitted to said station (B) with information redundancy.

8. The method as claimed in any one of the preceding claims, in which the pictures marked long-term are coded with a greater quality than the other pictures of the video sequence.

9. A computer program to be installed in a video processing apparatus (A), comprising instructions for implementing the steps of a video coding method as claimed in any one of claims 1 to 8 during an execution of the program by a calculation unit of said apparatus.

10. A video coder (1), comprising:
means (5-8, 10, 15) for coding successive pictures (F) of a video sequence so as to generate coding parameters, the coding of at least one picture being effected in relation to at least one previous picture of the video sequence;
means (9) for forming an output stream (φ) of the coder to be transmitted to a station (B) comprising a decoder (2), the output stream including said coding parameters as well as long-term marking commands for certain pictures of the video sequence and commands for unmarking pictures previously marked long-term, each picture marked long-term having to be retained in memory by the decoder until receipt of a command for unmarking said picture;
means for receiving, from said station, return information about the playback of the pictures of the video sequence by the decoder; and
means (10) for analyzing the return information so as to identify pictures that have not been played back or have been played back poorly by the decoder and, in response to the identification of a picture that has not been played back or has been played back poorly, controlling the coding means so that at least one following picture of the video sequence is coded in relation to a previous picture of the video sequence selected from among pictures comprising at least one picture marked long-term.

11. The video coder as claimed in claim 10, furthermore comprising means (16) for detecting a change of shot in the video sequence and means (10) responding to the detection of a change of shot by marking long-term a picture following the detected change of shot.

12. The video coder as claimed in claim 10 or 11, in which the return information comprises information produced upstream of the decoder (2), signaling good or bad reception of the stream by said station (B), and in which the means (10) for analyzing the return information comprise means for detecting first phases in which the stream is properly received by the station and second phases in which the reception of the stream by the station is disturbed, and means for long-term marking of pictures of the video sequence so as to regularly mark pictures in each first detected phase and to interrupt the regular marking in each second detected phase.

13. The video coder as claimed in any one of claims 10 to 12, in which the return information comprises information arising from the decoder (2), signaling the pictures of the sequence which have or have not been played back, and in which the means (10) for analyzing the return information comprise means for long-term marking pictures of the video sequence that are selected from among pictures which, according to the return information, have been properly played back.

14. The video coder as claimed in any one of claims 10 to 13, furthermore comprising means (16) for detecting a change of shot in the video sequence, in which the coding of at least one following picture of the video sequence in relation to a picture long-term marked in response to the identification of a picture that has not been played back or has been played back poorly is performed on condition that no change of shot is detected in the video sequence between said picture marked long-term and said following picture.

15. The video coder as claimed in any one of claims 10 to 14, in which the means for forming the output stream (φ) are controlled so as to transmit the coding parameters of the pictures marked long-term to said station (B) with information redundancy.

16. The video coder as claimed in any one of claims 10 to 15, in which the coding means (5-8) are controlled so as to code the pictures marked long-term with a greater quality than the other pictures of the video sequence.
